(19) United States
(12) Patent Application Publication
(10) Pub. No.: US 2023/0409678 A1
(43) Pub. Date: Dec. 21, 2023

(54) SAMPLE PROCESSING BASED ON LABEL MAPPING

(71) Applicant: LEMON INC., Grand Cayman (KY)

(72) Inventors: Hongyu XIONG, Los Angeles, CA (US); Yihan Yang, Los Angeles, CA (US)

(21) Appl. No.: 17/845,956

(22) Filed: Jun. 21, 2022

(51) Int. Cl. G06K 9/62

(52) U.S. Cl. CPC G06K 9/6227; G06K 9/6256; G06K 9/6267

(57) ABSTRACT

A method is proposed for sample processing. A first label for a training sample in a plurality of training samples is mapped into a second label, the first label being represented in a first label space and the second label being represented in a second label space smaller than the first label space. A plurality of classification models are obtained based on the second label and the training sample, a classification model describing an association relationship between a sample and a classification of a label, represented in the second label space, for the sample. A predication model is generated based on the plurality of classification models, the predication model describing an association relationship between a sample and a label, represented in the first label space, for the sample. The long tail effect in the original label space may be alleviated in building the predication model.

### FIELD

The present disclosure generally relates to sample processing, and more specifically, to methods, devices and computer program products for sample processing based on mapping labels for samples from a first label space into a second label space.

### BACKGROUND

Nowadays, the machine learning technique has been widely used in sample processing. For example, in a recommendation environment, objects such as videos, articles, and so on may be provided to users. A user may watch a video for two minutes, and another user may watch the video for five minutes. A label related to a sample (including video and user data) may be determined, and the label may indicate how long the user watches the video. There have been proposed solutions for predicting a trend of the label. However, due to the time lengths distribute among a large arrange and may involve the long tail effect, these solutions cannot output an accuracy predicting result. At this point, how to process the samples and predict accurate labels for the samples effectively becomes a hot focus.

### SUMMARY

In a first aspect of the present disclosure, there is provided a method for sample processing. In the method, a first label for a training sample in a plurality of training samples is mapped into a second label based on the first label and a plurality of first labels for the plurality of training samples, the first label and the plurality of first labels being represented in a first label space and the second label being represented in a second label space smaller than the first label space. A plurality of classification models is obtained based on the second label and the training sample, a classification model in the plurality of classification models describing an association relationship between a sample and a classification of a label, represented in the second label space, for the sample. A predication model is generated based on the plurality of classification models, the predication model describing an association relationship between a sample and a label, represented in the first label space, for the sample.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for sample processing according to the machine learning technique;

FIG. 2 illustrates an example diagram of a distribution of labels for samples according to implementations of the present disclosure;

FIG. 3 illustrates an example diagram of a prediction model including a plurality of classification models that are generated based on label mapping according to implementations of the present disclosure;

FIG. 4 illustrates an example diagram of a distribution of labels in a second label space for samples according to implementations of the present disclosure;

FIG. 5 illustrates an example diagram of new training data including a sample and a second label for the sample according to implementations of the present disclosure;

FIG. 6 illustrates an example diagram of a prediction model according to implementations of the present disclosure;

FIG. 7 illustrates an example diagram of a base model included in a prediction model according to implementations of the present disclosure;

FIG. 8 illustrates an example diagram of performance of a predication model according to implementations of the present disclosure;

FIG. 9 illustrates an example flowchart of a method for sample processing based on label mapping according to implementations of the present disclosure; and

FIG. 10 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

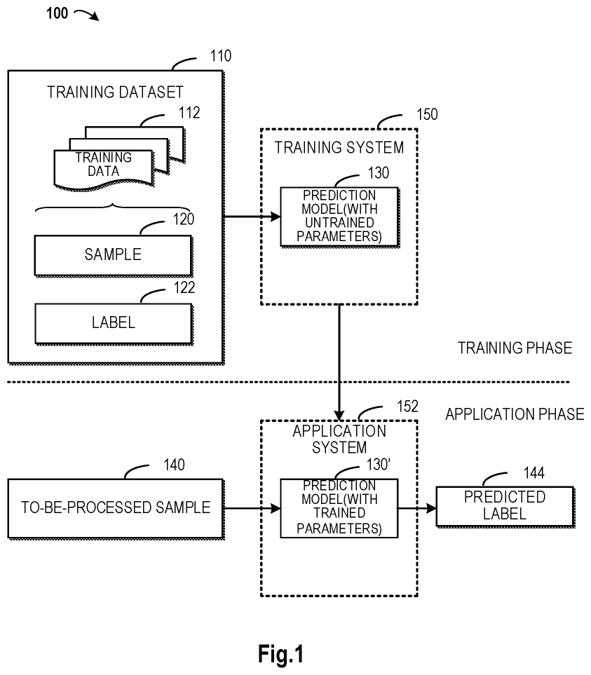

For the purpose of description, the following paragraphs will provide more details by taking a recommendation system as an example environment. In the recommendation system, various objects (such as videos, articles, messages, and the like) may be sent to the user. Sometimes, the user is interested in the object and then review the object for a long time. If the user is not interested in the object, he/she may review the object for a short time or even pass the object and do nothing. By now, solutions have been provided for generating a prediction model for predicting the time length that the user reviews the object. Hereinafter, reference will be made to FIG. 1 for more details about the prediction model, here FIG. 1 illustrates an example environment 100 for sample processing according to the machine learning technique.

In FIG. 1, a prediction model 130 may be provided for predicting the time length. Here, the environment 100 includes a training system 150 and an application system 152. The upper portion of FIG. 1 shows a training phase, and the lower portion shows an application phase. Before the training phase, the prediction model 130 may be configured with untrained or partly trained parameters (such as initial parameters, or pre-trained parameters). In the training phase, the prediction model 130 may be trained in the training system 150 based on a training dataset 110 including a plurality of training data 112. Here, each training data 112 may have a two-tuple format, and may include a sample 120 (for example, data associated with the object and the user) and a label 122 for the sample 120. Specifically, a large amount of training data 112 may be used to implement the training phase iteratively. After the training phase, the parameters of the prediction model 130 may be updated and optimized, and a prediction model 130′ with trained parameters may be obtained. At this point, the prediction model 130′ may be used to implement the predication task in the application phase. For example, the to-be-processed sample 140 may be inputted into the application system 152, and then a corresponding predicted label 144 may be outputted.

In FIG. 1, the training system 150 and the application system 152 may include any computing system with computing capabilities, such as various computing devices/systems, terminal devices, servers, and so on. The terminal device may involve any type of mobile device, fixed terminal, or portable device, including mobile phones, desktop computers, laptop computers, notebook computers, netbook computers, tablet computers, media computers, multimedia tablets, or any combination of the foregoing, including the accessories and peripherals of these devices or any combination thereof. Servers may include but are not limited to mainframes, edge computing nodes, computing devices in cloud environments, and so on. It should be understood that the components and arrangements in the environment 100 in FIG. 1 are only examples, and a computing system suitable for implementing the example implementation described in the present disclosure may include one or more different components, and other components. For example, the training system 150 and the application system 152 may be integrated in the same system or device.

As illustrated in FIG. 1, the training dataset 110 may include historical training data 112 collected from data logs of the recommendation system according to requirements of corresponding laws and regulations and relevant rules. For example, the object may be a video provided to the user and then the sample 120 may include embeddings related to the object and the user, and the label 122 may indicate the time length that the user watches the video. However, the time length may vary in a wide range, and then the long tail effect may occur.

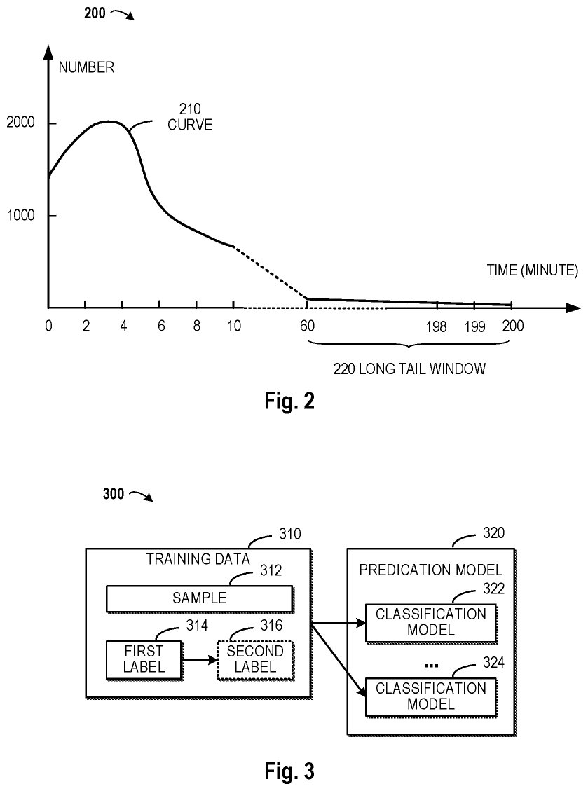

Reference will be made to FIG. 2 for explaining the long tail effect, here FIG. 2 illustrates an example diagram 200 of a distribution of labels for samples according to implementations of the present disclosure. As illustrated in FIG. 2, a curve 210 indicates a distribution of labels for the samples. The horizontal axis indicates an original label space of the labels, for example, the labels may indicate how many minutes the user watches the video. It is to be understood that the label only represents a time duration and does not relate to identifying contents in the video. In another environment where the user reads an article or a news report, the label may indicate the time duration that the user spent in the article or report, but does not involve contents of the article or report. The vertical axis indicates the number of the labels. Supposing the training dataset 110 includes 20,000 training data, then there may be 20,000 labels for the 20,000 samples. In FIG. 2, the curve 210 indicates that most users watch the video for about 0-10 minutes. As the time length increases, the number of users decreases and very few users watch the video for more than 60 minutes. In FIG. 2, although there are some labels in the long tail window 220 (for example, between 60 to 200 minutes), the number of the labels is very low compared with total number of the labels.

The above situation relates to the long tail effect. Here, the long tail effect is a statistical pattern of distribution that occurs when a large share of occurrences are farther away from the center or head of distribution. This means that a long tail distribution includes many values that are far away from the mean value. Due to the uneven distribution of the labels, the long tail effect increases the difficulty of predication.

By now, regression models have been developed for prediction model related to the long tail effect. Usually, the mean-square-error obtained from the training data are used as a loss for training the prediction model. However, the mean-square-error leads the trained prediction model to output a predicated label that is near a mean value of the labels in the training data, but the trained prediction model cannot effectively consider contributions from labels in the long tail window 220. In turns, the trained predication model 130 cannot provide accurate predication results.

In view of the above, the present disclosure proposes a sample processing solution based on label mapping. As interests of users vary, the labels exhibit the long tail effect when the labels are represented in minutes. Considering the above, it is proposed that the label in the time space may be mapped into a new label space with a smaller size than the original label space. Next, the prediction model may be built based on the sample and the new label in the new label space, such that the long tail effect in the original label space may be alleviated in building the predication model.

Hereinafter, referring to FIG. 3 for more details about the sample processing. FIG. 3 illustrates an example diagram 300 of a prediction model including a plurality of classification models that are generated based on label mapping according to implementations of the present disclosure. As illustrated in FIG. 3, a prediction model 320 may be trained by the training data 310, and the training data 310 may include a sample 312 and a first label 314. Here, the sample 312 may include embeddings related to various factors that may affect the first label 314, and the first label 314 may be represented in a first label space (i.e., the original label space). Continuing the above example of the recommendation system, the sample 312 may includes embeddings related to the user and the video, and the first label 314 may indicate the time length.

In order to alleviate the long tail effect in the first label space, the first label 314 may be mapped into a second label 316. Here, the second label 316 may be represented in a smaller label space and thus the long tail effect in the first label space may be alleviated. In some implementations of the present disclosure, the second label space may be defined by a plurality of buckets. At this point, the second label may refer to a bucket in the plurality of buckets, and thus the first label 314 may be mapped from a continuous space into an ordinal space.

In FIG. 3, a plurality of classification 322, . . . , and 324 may be obtained based on the sample 312 and the second label 316. Here, a classification model in the plurality of classification models 322, . . . , and 324 may describe an association relationship between a sample and a classification of a label, represented in the second label space, for the sample. In the context of the present disclosure, the classification may relate to a probability of whether the label matches a classification criterion in the second label space. For example, a classification model 322 may relate to a classification criterion whether the label is greater than or equal to a predefined classification value in the second label space. Similarly, the classification model 324 may relate to another classification value in the second label space.

Further, the prediction model 320 may be generated based on the plurality of classification models 322, . . . , and 324. The classification models 322, . . . , and 324 solve a problem of classifying the label into a corresponding classification, which is a simple problem compared with the predication model 320 for predicting a time length (which is suffered from the long tail effect). Therefore, the classification models 322, . . . , and 324 may adopt simple network structures and may be better trained with the sample 312 and the second label 316. Then, the prediction model 320 may be generated in a more effective and easy way by mapping the first label 314 into the second label 316.

In implementations of the present disclosure, various ways may be adopted for mapping the first label 314 into the second label 316. Specifically, a mapping function may be determined for mapping a label (in the first label space) into a label (in the second label space). Here, the first label space represents a continuous space, and the second label space represents an ordinal space. The mapping function may depend on various aspects. For example, in order to reflect a relationship between the first label and other first labels (in the first label space) for other samples in the training dataset 110, a normalizing function may be determined for the label mapping.

In implementations of the present disclosure, a reference base (such as a ¼ quantile, a ½ quantile, a ¾ quantile, or a mean value) may be determined from all the first labels for the samples in the training dataset 110. Supposing the training dataset includes 20,000 training data and the ½ quantile is selected as the reference base, then a label for the 10000^{th} training sample in the training dataset 110 may be used as the reference base in the normalizing function. At this point, with respect to the i^{th} first label in the first label space, the i^{th} first label may be converted into a normalized value based on Formula 1.

$${label}_{i}^{norm} = n o r m ( l a b e {l}_{i} ) = \frac{l a b e {l}_{i}}{{label}_{ref}}$$

In Formula 1, labelᵢ^{norm} represents the normalized value for labelᵢ, norm( ) represents the normalizing function, labelᵢ represents the i^{th} first label (in the first label space) for the i^{th} sample in the training dataset 110, label_{ref} represents the reference base for the normalizing function. Here, the labelᵢ^{norm} is an intermedia value that is represented in a third label space which is different from the first and second label spaces.

In implementations of the present disclosure, label_{ref} may be determined based on a quantile of the plurality of first labels. Alternatively and/or in addition to, the label_{ref} may be determined based on a mean value of the plurality of first labels. Further, the label_{ref} may be determined based on a summation of the plurality of first labels or the maximum one in the plurality of first labels. At this point, depending on the way for selecting the reference base, the third label space may have different ranges. For example, if the maximum label is used as the reference base, then the third label space may have a range of [0, 1]. In another example, if the first label space has a range of [0, 200] and the mean value (for example, lable_{ref}=5) is used as the reference base, then the third label space may have a range of [0, 40].

With these implementations of the present disclosure, the first label space (with a relatively large size) may be mapped into the second label space with a smaller size. Therefore, the long tail effect may be alleviated to a certain degree. Further, if the plurality of first labels are scattered among the first label space, then a compressing function may be used for compressing the first label space into a compressed space. For example, a square root (or a cube root, and the like) may be determined from the first label, and then the square root may be normalized. At this point, the normalized value may be determined based on Formula 2 as below:

$${label}_{i}^{norm} = norm ( comp ( {label}_{i} ) ) = \frac{comp ( {label}_{i} )}{{label}_{ref}} \qquad Formula 2$$

In Formula 2, comp( ) represents the compressing unction, and other symbols may have the same meanings as those in Formula 1. With these implementations of the present disclosure, the first label space may be further compressed and thus the long tail effect may further be reduced.

It is to be understood that the normalized value is obtained based on a division operation and thus the normalized value is represented as a real number. Due to the further classification processing does not need the high precision real number and the real number may cost more computing resources, the real number may further be converted into an integer number based on a bucket function. Then, the bucket function may be determined for converting the normalized value into the label in the second label space.

In implementations of the present disclosure, the bucket function may be determined based on a comparison between the normalized value and the third label space. In order to determine the bucket function, the number of the buckets may be determined first, for example, based on a predetermined accuracy level. For example, a high accuracy level may define that the third label space should be divided into 100 buckets, a medium accuracy level may define that the third label space should be divided into 80 buckets, and a low accuracy level may define that the third label space should be divided into 50 buckets. At this point, the third label space may be divided into a plurality of buckets based on the determined number of the buckets, and then the bucket function may be determined based on a comparison between the normalized value and the plurality of buckets. Supposing the third label space has a range of [min, max] and is divided into N buckets, then the bucket function may be defined as below:

$$Formula 3$$

$$bucket ( label ) = \{ \begin{matrix}\begin{matrix}0 , where min \leq label < min + size , \\ …\end{matrix} \\ k - 1 , where min + ( k - 1 ) * size \leq label < min + k * size , \\ … \\ N - 1 , where min + ( N - 1 ) * size \leq label \leq min + N * size\end{matrix}$$

$$where size = \frac{max - min}{N}$$

In Formula 3, label represents a label in the third label space, min represents a lower boundary of the third label space, max represents an upper boundary of the third label space, size represents a size of the bucket, and N represents a total number of the buckets. Other symbols may have the same meanings as those in the above formulas. Supposing the high accuracy level is selected, the second label space may include 100 buckets, and then the second label space may be represented as {1, 2, 3 . . . , 100} (100 integer numbers in [1, 100]).

There are two main reasons for introducing the bucket function. First, qualities for the labels are uneven, and there is noise in the labels. The bucket function may reduce the noise in the labels by classifying the label in a corresponding bucket. Second, the classification model needs to learn how to distinguish high labels and low labels. In other words, labels with a large gap may be distinguished. However, for labels with very close values, the classification model does not need to distinguish them in an accurate way. Accordingly, the bucket function may help to reduce the noise and also achieve the classification purpose with lower computing resources.

With Formula 3, the normalized value may be mapped from the third label space into the second label space. Here, the label mapping may be implemented by implementing the normalizing function first and then the bucket function. In other words, based on the above normalizing functions (shown in Formula 1 or Formula 2) and the bucket function (shown in Formula 3), the mapping function may be represented as below:

mapping(labelᵢ)=bucket(norm(labelᵢ)) Formula 4

In Formula 4, mapping( ) represents the mapping function, bucket( ) represents the bucket function (which may be determined based on Formula 3), and norm( ) represents the normalizing function (which may be determined based on Formula 1 or Formula 2). At this point, the first label 314 may be mapped into the second label 316 according to Formula 4.

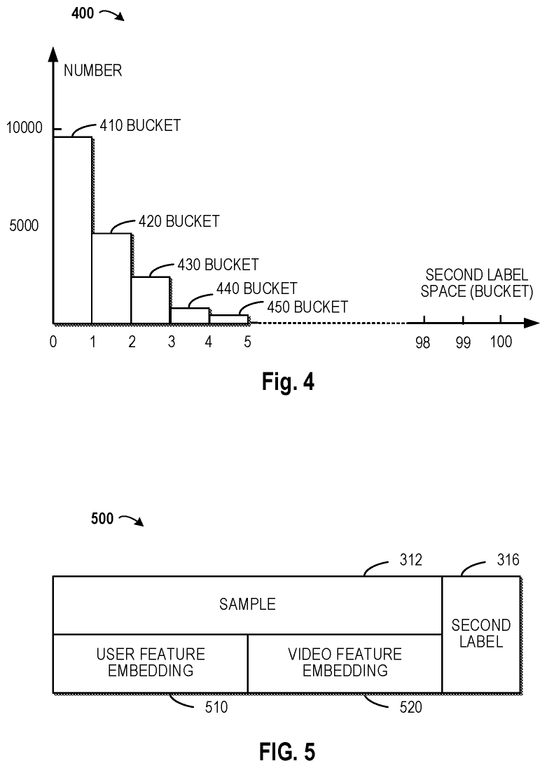

In implementations of the present disclosure, each first label in the training dataset 110 may be processed based on Formula 4, and then all the first labels in the training dataset 110 may be mapped into corresponding second labels in the second label space. Hereinafter, reference will be made to FIG. 4 for details about the second label space. FIG. 4 illustrates an example diagram 400 of a distribution of labels in a second label space for samples according to implementations of the present disclosure. As illustrated in FIG. 4, all the first labels with continuous real numbers in the range of [0, 200] are mapped into corresponding ordinal integer numbers in the range of {1, 2, . . . , 100}. Here, buckets may include different number of labels. For example, a bucket 410 includes nearly 9,000 labels in the second label space, a bucket 420 includes nearly 4,000 labels, a bucket 430 includes nearly 2,000 labels, subsequent buckets 440 and 450 include less labels, respectively.

With these implementations of the present disclosure, the size of second label space is significantly smaller than the size of the first label space. Further, label noise in the first label space is removed during the label mapping procedure, and thus the sample 312 and the second label 316 may train the predication model 320 in a more accuracy way. At this point, new training date may be built for the further training based on the sample 312 and the second label 316, so as to increase the accuracy level of the predication model 320.

FIG. 5 illustrates an example diagram 500 of new training data including a sample and a second label for the sample according to implementations of the present disclosure. As illustrated in FIG. 5, the sample 312 is retrieved from the original training data, and in the environment of the recommendation system, the sample 312 may include embeddings of various aspects that may affect the first label 314. For example, the sample 312 may include: user feature embedding 510 for describing various aspects of a user to which the video is provided; and video feature embedding 520 for describing various aspects of the video. For example, the video feature may include a length of the video, an encoding format of the video, and a resolution of the video, and so on. It is to be understood that all the embeddings are represented in a vector format and the original sensitive information related to the user and the video are invisible. Further, the new training data includes the second label 316 that is mapped from the first label 314 by the mapping function.

It is to be understood that FIG. 5 just provides an example of the new training data that is generated from the training data 310. In implementations of the present disclosure, all the 20,000 training data in the training dataset 110 may be subjected to the similar processing and thus 20,000 new training data may be obtaining for generating the classification models 322, . . . , and 324.

Having described details about the label mapping and generating the new training data, the following paragraphs will provide more information about obtaining the multiple classification models 322, . . . , 324 and generating the prediction model 320 based on the multiple classification models. In implementation of the present disclosure, the predication model 320 may be generated based on the regression predication theory. Specifically, based on the regression predication theory, the following Formula 5 may be used for predicating a label for the training sample (represented by an embedding of x):

predication(x)=Σᵢ₌₁^{N}i*P(i|x)=1*P(1|x)+2*P(2|x)+3*P(3|x)+ . . . +N*P(N|x) Formula 5

In Formula 5, x represents the inputted embedding of the training sample, predication( ) represents a probability of the label for the training sample, and it may be represented as a summation of i*P(i|x) (where i=1, 2, 3, . . . , N, N represents a number of the buckets in the second label buckets). P(i|x) represents a probability that the label predicted from x equals to i. Further, Formula 5 may be converted into Formula 6 based on the mathematical transformation:

$$Formula 6$$

$$\begin{matrix}predication ( x ) = {\sum }_{i = 1}^{N} i * P ( i \vert x ) \\ = 1 * P ( 1 \vert x ) + 2 * P ( 2 \vert x ) + 3 * P ( 3 \vert x ) + … + N * P ( N \vert x ) \\ = ( P ( 1 \vert x ) + P ( 2 \vert x ) + P ( 3 \vert x ) + … + P ( N \vert x ) ) + ( P ( 2 \vert x ) + \\ P ( 3 \vert x ) + … + P ( N \vert x ) ) + x ) ) + \\ ( P ( 3 \vert x ) + … + P ( N \vert x ) ) + … + ( P ( N \vert x ) \\ = P ( \geq 1 \vert x ) + P ( \geq 2 \vert x ) + P ( \geq 3 \vert x ) + … + P ( \geq N \vert x ) \\ = {\sum }_{i = 1}^{N} P ( \geq i \vert x )\end{matrix}$$

In Formula 6, P(≥i|x) represent a probability that the label predicated from the embedding x is above i, and other symbols may have the same meanings as those in the above formulas. Here, P(≥i|x) may be implemented by a classification model and thus the technical problem for building the predication model 320 based on the regression predication theory (as shown in Formula 5) is converted into building the prediction model 320 based on multiple classification models (as shown in Formula 6). Compared with the regression predication model, structures and training objectives of the classification models are easier to achieve, which may reduce the complexity and cost for generating the prediction model directly based on the regression predication theory.

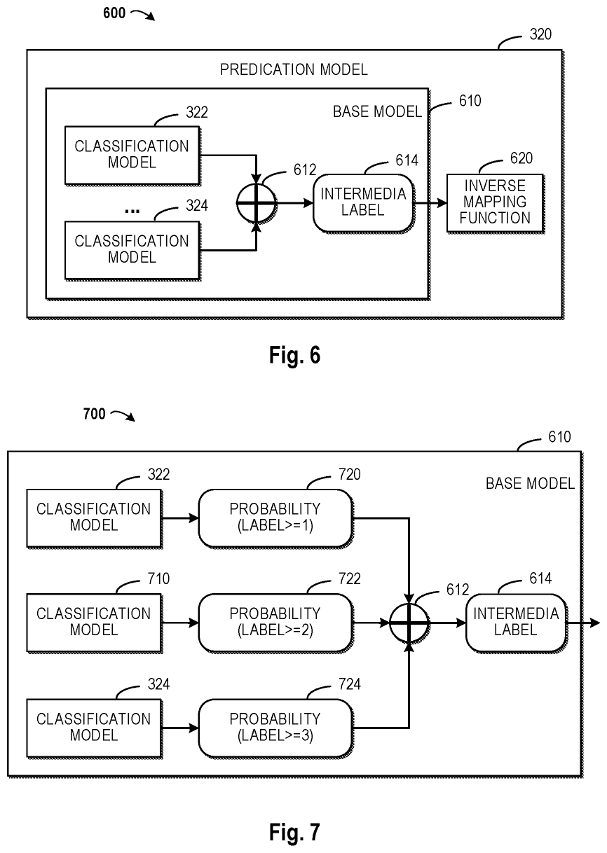

Hereinafter, reference will be made to FIG. 6 for more information about the classification models 322, . . . , 324 and the predication model 320. FIG. 6 illustrates an example diagram 600 of a prediction model 320 according to implementations of the present disclosure. As illustrated in FIG. 6, the predication model 320 includes a base model 610 (which is built based on a summation of the plurality of classification 322, . . . , and 324) and an inverse mapping function 620. Here, each of the classification models 322, . . . , and 324 represents a corresponding probability of P(≥i|x) (where i=1, 2, 3, . . . , N), and may be trained by the new training data shown in FIG. 5, such that the base model 610 may describe an association relationship between the samples and corresponding second labels.

In the prediction model 320, the number of the classification models reflects the accuracy level of the prediction model 320, and a greater number may lead to a higher accuracy level. Usually, the accuracy level of the prediction model 320 depends on the proportion of the new training data that cover the second label space. Returning to FIG. 4, most of the second labels are clustered in the top buckets (for example, the top three buckets 410, 420 and 430), and only a small number of labels in a tail (such as labels in the buckets 440, 450 and other subsequent buckets) are far away from the center of the label distribution. Due to labels in the tail are significantly small after the label mapping, this tail plays relatively weak contributions to the prediction model 320. Due to the labels in the tail greatly increasing the complexity level and the resource cost, only the top buckets may be considered in generating the classification models. Therefore, a balance may be found between the complexity, cost and the accuracy level.

At this point, an appropriate number of the top buckets may be determined first, for example, based on a distribution of a plurality of second labels among the second label space. As most of the second labels are located in the top buckets 410, 420, and 430, and then the number of these top buckets may be used for determining how many classification models may be generated. In another example, a threshold ratio may be determined first, and then the number may be determined according to the threshold ratio. Supposing the threshold ratio is set as 85% and the first three buckets 410, 420 and 430 cover more than 85% of the second labels, then the number may be set to three. Further, three classification models may be generated. If the threshold ratio is set to a higher value, then the number may be increased (for example, increased to 4).

Referring to FIG. 7 for more details of the base model 610 and the multiple classification models. FIG. 7 illustrates an example diagram 700 of a base model 610 included in the prediction model 320 according to implementations of the present disclosure. In implementations of the present disclosure, once the bucket number is determined, the number of the classification models is determined. Here, a classification model may be generated for a bucket. Supposing the number of the classification models are determined as M=3, then three classification models may be generated for the top three buckets 410, 420, and 430 in the second label space. At this point, Formula 7 may be determined from Formula 6.

predication′(x)=Σᵢ₌₁^{M}P(≥i|x)=P(≥1|x)+P(≥2|x)+P(≥3|x) Formula 7

In Formula 7, predication′(x) represents a simplified predication formula, M (where M=3) represents the number of the classification models, and other symbols have the same meaning as those in the previous formula. In FIG. 7, the classification model 322 may be generated for providing a probability 720 whether the predicted label matches a classification criterion (for example, being greater than or equal to a classification value (i.e., 1)). The classification model 710 may be generated for providing a probability 722 related to another classification criterion (for example, being greater than or equal to a classification value (i.e., 2)). Similarly, the classification model 324 may be generated for providing a probability 724 related to a further classification criterion (for example, being greater than or equal to a classification value (i.e., 3).

Here, the classification models 322, 710, and 324 may be trained by the new training date with the format shown in FIG. 5. In implementations of the present disclosure, an initial classification model may be obtained. For example, a common classification network structure may be taken as the initial classification model, and then the initial classification model may be trained by the plurality of new training data. For example, a classification of whether the second label matches a classification criterion in the second label space may be determined based on the new training data.

In training the classification model 322, the second label 316 is compared with the classification criterion (for example, greater than or be equal to “1”). If the second label 316 is greater than or equal to “1,” then a ground truth probability label may be set to “1,” else the ground truth probability label may be set to “0.” Further, a loss function may be built for the classification model 322 to represent a difference between the ground truth probability label and a probability that is predicted for the sample 312. Then, the classification model 322 may be trained towards a direction for minimizing the lost function in an iteratively way with all the new training data. It is to be understood that this paragraph just provides an example of the classification criterion, alternatively and/or in addition to, the classification criterion may be selected from any of being greater than a classification value, being less than a classification value, being less than or equal to a classification value, and the like.

It is to be understood that the classification criterion may vary for different classification models. For the classification model 710, the classification criterion may be set to: whether the second label 316 is greater than or equal to “2.” Similarly, if the second label 316 is greater than or equal to “2,” then the ground truth probability label may be set to “1,” else the ground truth probability label may be set to “0.” Based on the plurality of new training data, the classification model 710 may be trained for outputting a probability 722 indicating whether a predicated label is greater than or equal to “2.” Further, for the classification model 324, the classification criterion may be set to: whether the second label 316 is greater than or equal to “3.” Then the classification model 324 may be trained for outputting a probability 724 indicating whether a predicated label is greater than or equal to “3.”

In implementations of the present disclosure, the classification models 322, 710 and 324 may be trained in an iteratively way by the plurality of new training data. Here, these classification models may be trained individually and/or in combination. Based on the above, the three items (i.e., P(≥i|x), i=1, 2, 3) in the above Formula 7 may be determined by the three classification models 322, 710, and 324, respectively. Further, based on Formula 7, probabilities outputted by the three classification models may be added together at a summator 612, so as to provide an intermedial label 614 for the base model 610. Here, the intermedial label 614 indicates a predicated label (represented in the second label space) for the inputted sample. At this point, the base model 610 may describe an association relationship between a sample and a label in the second label space.

Due to the intermedia label 614 is in the second label space, which is represented by the bucket and cannot indicate how long the user watches the video. The intermedia label 614 should be mapped back to the first label space, such that it may indicate the real meaning of the label (for example, the time length that the user watches the video). Returning to FIG. 6, the predication module 320 further comprise an inverse mapping function 620 for mapping a label in the second label space into a label in the first label space. Here, the intermedia label 614 may be processed by the inverse mapping function 620, such that it may be converted back into the first label space.

In implementations of the present disclosure, the inverse mapping function 620 is an inverse function of the mapping function. In other words, the inverse mapping function 620 mapping a label in the second label space back into a label in the first label space. With respect to the mapping function in Formula 5, the inverse mapping function 620 may be defined as below:

mapping⁻¹(labelⱼ)=norm⁻¹(bucket⁻¹(labelⱼ)) Formula 8

In Formula 8, mapping⁻¹( ) represents an inverse function of the mapping function, labelⱼ represents a label in the second label space, norm⁻¹( ) and bucket⁻¹( ) represent inverse functions of the normalizing function and the bucket function, respectively. Due to the inverse mapping function only relates to a mathematical transformation for the mapping function, details will be omitted hereinafter.

Further, the intermedia label 614 may be converted from the second label space into the first label space according to Formula 8. With implementations of the present disclosure, the long tail effect in the first label space is alleviated by the label mapping. Further, the predication model 320 is built based on classification models, which converts the complex regression predication model into multiple simpler classification models. Therefore, the accuracy of the prediction model 320 is increased.

In implementations of the present disclosure, the predication model 320 may accept an inputted sample and output a predicted label for the inputted sample. Due to the predication model 320 is more accurate than the conversational regression predication model, the predicated label may be more accurate and reliable. Specifically, the target t sample may be inputted in the base model 610 for outputting three probabilities, and then the probabilities may be added up to form the intermedia label. As the intermedia label 614 is represented in the second label space, it should be converted into the first label space by the inverse mapping function 620. Since the inverse mapping function 620 are based on mathematics operations, the inverse mapping function will not introduce errors into the target t label. Therefore, the target t label may indicate a reliable value in the first label space.

Continuing the above example in the recommendation system, a target t sample including user feature embedding and video feature embedding may be processed by the predication model 320. Specifically, the target t sample may be inputted into the classification models 322, 710 and 324, respectively. At this point, the classification models 322 may output a probability indicating whether a label predicated from the target t sample is greater than or equal to 1, the classification models 710 may output a probability indicating whether a label predicated from the target t sample is greater than or equal to 2, and the classification models 322 may output a probability indicating whether a label predicated from the target t sample is greater than or equal to 3. Further, an intermedia label may be determined based on a summation of the three outputted probabilities.

Supposing all the three classification models 322, 710 and 324 output 1, the intermedia label may be determined as 1+1+1=3. Afterwards, the intermedia label may be converted from the second label space back to the first label space based on the inverse mapping function 620. The intermedia label “3” may be inputted into the above Formula 8, and then the intermedia label “3” may be converted into a target t label (for example, target t label=12.5) in the first label space. It indicates that the user may possibly watch the provided video for about 12.5 minutes. Similarly, another target t sample may be inputted into the prediction model 320, supposing the classification models 322, 710 and 324 output 1, 0 and 0 respectively, the intermedia label may be determined as 1+0+0=1. At this point, the inverse mapping function 620 may output a target t label (for example, target t label=4) in the first label space. Here, the target t label indicates that the user will possibly watch the video for 4 minutes.

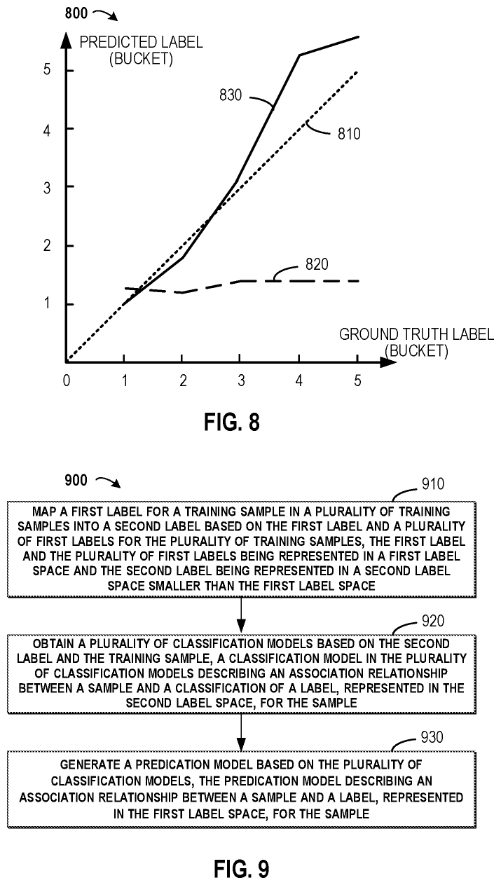

FIG. 8 illustrates an example diagram 800 of performance of a predication model according to implementations of the present disclosure. As illustrated in FIG. 8, the horizontal axis indicates the bucket for the ground truth and the vertical axis indicates the predicated bucket. A line 810 indicates the performance of an ideal predication model, which always outputs the accurate predicated bucket that is equal to the ground truth. A curve 820 indicates the performance of a conventional prediction model based on the regression theory. As shown, the shape of the curve 820 remains approximately in the horizontal direction, and the predicted value does not increase with the ground truth. Therefore, the accuracy level of the conventional predication model is not satisfying.

In FIG. 8, a curve 830 indicates the performance of the prediction model 320 which is built based on label mapping and multiple classification models. Due to the label mapping reduce the potential errors caused by the long tail effect in the first label space, and the classification models implement the complex regression model, the prediction model 320 exhibits better performance than the conversional regression model. As shown by the curve 830, the predicated label increases with the ground truth label, although the curve 830 does not exactly match the ideal line 810, the variation tendency of the curve 830 is inconsistent with the line 810. Therefore, when processing samples involving the long tail effect, the predication model 320 is more accurate and reliable than the conversional prediction model.

Although the above paragraphs describe implementations of the present disclosure in the recommendation system, where the sample represents embeddings related to the user and the video and the label represents the time length that the user watches the video, the proposed solution may be implemented in other environments. For example, in a computing system, the sample may represent embeddings related to parameters related to an error in the computing system (such as a type of the error, a reason of the error, and the like), and the label may represent a time length for troubleshooting. At this point, a prediction model may be generated by mapping the label in a continuous time space into a bucket space. Alternatively and/or in addition to, in a market management system, the sample may represent embeddings relates to factors that may affect a price of a product, and the label may represent a price of the product. In this situation, a predication model may be generated by mapping the label in a continuous space into a bucket space. Therefore, the long tail effect in the original label space (for example, the time length for troubleshooting, and the price of the product) may be reduced and the accuracy level of the predication models may be increased.

The above paragraphs have described details for the sample processing. According to implementations of the present disclosure, a method is provided for sample processing. Reference will be made to FIG. 9 for more details about the method, here FIG. 9 illustrates an example flowchart of a method 900 for sample processing based on multiple time windows according to implementations of the present disclosure. At a block 910, a first label for a training sample in a plurality of training samples is mapped into a second label based on the first label and a plurality of first labels for the plurality of training samples, the first label and the plurality of first labels being represented in a first label space and the second label being represented in a second label space smaller than the first label space. At a block 920, a plurality of classification models is obtained based on the second label and the training sample, a classification model in the plurality of classification models describing an association relationship between a sample and a classification of a label, represented in the second label space, for the sample. At a block 930, a predication model is generated based on the plurality of classification models, the predication model describing an association relationship between a sample and a label, represented in the first label space, for the sample.

In implementations of the present disclosure, mapping the first label into the second label comprises: determining a mapping function for mapping a label in the first label space into a label in the second label space, the first label space representing a continuous space and the second label space representing an ordinal space; and determining the second label based on the first label and the mapping function.

In implementations of the present disclosure, determining the mapping function comprises: determining a normalizing function for converting the label in the first label space into a normalized value in a third label space based on the label in the first label space and the plurality of first labels; and determining a bucket function for converting the normalized value into the label in the second label based on a comparison between the normalized value and the third label space.

In implementations of the present disclosure, determining the bucket function comprises: determining the number of the buckets based on a predetermined accuracy level; dividing the third label space into a plurality of buckets based on the determined number of the buckets; and obtaining the bucket function based on a comparison between the normalized value and the plurality of buckets.

In implementations of the present disclosure, obtaining the plurality of classification models comprises: determining the number of the plurality of classification models based on a distribution of a plurality of second labels for the plurality of training samples among the second label space, the plurality of second labels being represented in the second label space; and obtaining the plurality of classification models based on the determined number.

In implementations of the present disclosure, obtaining the plurality of classification models comprises: with respect to the classification model in the plurality of classification models, obtaining the classification model by training an initial classification model with the training sample and a classification of whether the second label matches a classification criterion in the second label space.

In implementations of the present disclosure, determining the predication model comprises: generating a base model based on the plurality of classification models; determining an inverse mapping function for mapping a label in the second label space into a label in the first label space; and determining the predication model based on the base model and the inverse mapping function.

In implementations of the present disclosure, generating the base model comprises: generating the predication model based on a summation of the plurality of classification models.

In implementations of the present disclosure, the method 900 further comprises: in response to receiving a target t sample, determining a target t label in the first label space for the target t sample based on the target t sample and the prediction model.

In implementations of the present disclosure, determining the target t label base on the target t sample and the prediction model comprises: determining an intermedia label in the second label space based on the target sample and the base model in the prediction model; and determining the target label based on the intermedia label and the inverse mapping function.

According to implementations of the present disclosure, an apparatus is provided for sample processing. The apparatus comprises: a mapping unit, configured for mapping a first label for a training sample in a plurality of training samples into a second label based on the first label and a plurality of first labels for the plurality of training samples, the first label and the plurality of first labels being represented in a first label space and the second label being represented in a second label space smaller than the first label space; an obtaining unit, configured for obtaining a plurality of classification models based on the second label and the training sample, a classification model in the plurality of classification models describing an association relationship between a sample and a classification of a label, represented in the second label space, for the sample; and a generating unit, configured for generating a predication model based on the plurality of classification models, the predication model describing an association relationship between a sample and a label, represented in the first label space, for the sample. Further, the apparatus may comprise other units for implementing other steps in the above method.

According to implementations of the present disclosure, an electronic device is provided for implementing the above method. The electronic device comprises: a computer processor coupled to a computer-readable memory unit, the memory unit comprising instructions that when executed by the computer processor implements a method for sample processing. The method comprises: mapping a first label for a training sample in a plurality of training samples into a second label based on the first label and a plurality of first labels for the plurality of training samples, the first label and the plurality of first labels being represented in a first label space and the second label being represented in a second label space smaller than the first label space; obtaining a plurality of classification models based on the second label and the training sample, a classification model in the plurality of classification models describing an association relationship between a sample and a classification of a label, represented in the second label space, for the sample; and generating a predication model based on the plurality of classification models, the predication model describing an association relationship between a sample and a label, represented in the first label space, for the sample.

In implementations of the present disclosure, mapping the first label into the second label comprises: determining a mapping function for mapping a label in the first label space into a label in the second label space, the first label space representing a continuous space and the second label space representing an ordinal space; and determining the second label based on the first label and the mapping function.

In implementations of the present disclosure, determining the mapping function comprises: determining a normalizing function for converting the label in the first label space into a normalized value in a third label space based on the label in the first label space and the plurality of first labels; and determining a bucket function for converting the normalized value into the label in the second label based on a comparison between the normalized value and the third label space.

In implementations of the present disclosure, determining the bucket function comprises: determining the number of the buckets based on a predetermined accuracy level; dividing the third label space into a plurality of buckets based on the determined number of the buckets; and obtaining the bucket function based on a comparison between the normalized value and the plurality of buckets.

In implementations of the present disclosure, obtaining the plurality of classification models comprises: determining the number of the plurality of classification models based on a distribution of a plurality of second labels for the plurality of training samples among the second label space, the plurality of second labels being represented in the second label space; and obtaining the plurality of classification models based on the determined number.

In implementations of the present disclosure, obtaining the plurality of classification models comprises: with respect to the classification model in the plurality of classification models, obtaining the classification model by training an initial classification model with the training sample and a classification of whether the second label matches a classification criterion in the second label space.

In implementations of the present disclosure, determining the predication model comprises: generating a base model based on the plurality of classification models; determining an inverse mapping function for mapping a label in the second label space into a label in the first label space; and determining the predication model based on the base model and the inverse mapping function.

In implementations of the present disclosure, generating the base model comprises: generating the predication model based on a summation of the plurality of classification models.

In implementations of the present disclosure, the method further comprises: in response to receiving a target t sample, determining a target t label in the first label space for the target t sample based on the target t sample and the prediction model.

In implementations of the present disclosure, determining the target t label base on the target t sample and the prediction model comprises: determining an intermedia label in the second label space based on the target sample and the base model in the prediction model; and determining the target label based on the intermedia label and the inverse mapping function.

According to implementations of the present disclosure, a computer program product, the computer program product comprising a computer readable storage medium having program instructions embodied therewith, the program instructions executable by an electronic device to cause the electronic device to perform the method 800.

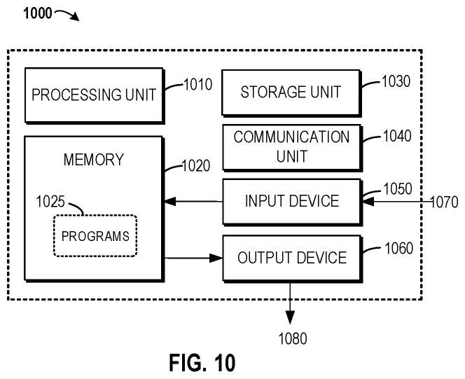

FIG. 10 illustrates a block diagram of a computing device 1000 in which various implementations of the present disclosure can be implemented. It would be appreciated that the computing device 1000 shown in FIG. 10 is merely for purpose of illustration, without suggesting any limitation to the functions and scopes of the present disclosure in any manner. The computing device 1000 may be used to implement the above method 1000 in implementations of the present disclosure. As shown in FIG. 10, the computing device 1000 may be a general-purpose computing device. The computing device 1000 may at least comprise one or more processors or processing units 1010, a memory 1020, a storage unit 1030, one or more communication units 1040, one or more input devices 1050, and one or more output devices 1060.

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller, or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk, or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem, and the like) enabling the computing device 1000 to communicate with one or more other computing devices, if required. Such communication can be performed via input/output (I/O) interfaces (not shown).

In some implementations, instead of being integrated in a single device, some, or all components of the computing device 1000 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for sample processing, comprising:
mapping a first label for a training sample in a plurality of training samples into a second label based on the first label and a plurality of first labels for the plurality of training samples, the first label and the plurality of first labels being represented in a first label space and the second label being represented in a second label space smaller than the first label space;
obtaining a plurality of classification models based on the second label and the training sample, a classification model in the plurality of classification models describing an association relationship between a sample and a classification of a label, represented in the second label space, for the sample; and
generating a predication model based on the plurality of classification models, the predication model describing an association relationship between a sample and a label, represented in the first label space, for the sample.

2. The method of claim 1, wherein mapping the first label into the second label comprises:
determining a mapping function for mapping a label in the first label space into a label in the second label space, the first label space representing a continuous space and the second label space representing an ordinal space; and
determining the second label based on the first label and the mapping function.

3. The method of claim 2, wherein determining the mapping function comprises:
determining a normalizing function for converting the label in the first label space into a normalized value in a third label space based on the label in the first label space and the plurality of first labels; and
determining a bucket function for converting the normalized value into the label in the second label based on a comparison between the normalized value and the third label space.

4. The method of claim 3, wherein determining the bucket function comprises:
determining the number of the buckets based on a predetermined accuracy level;
dividing the third label space into a plurality of buckets based on the determined number of the buckets; and
obtaining the bucket function based on a comparison between the normalized value and the plurality of buckets.

5. The method of claim 1, wherein obtaining the plurality of classification models comprises:
determining the number of the plurality of classification models based on a distribution of a plurality of second labels for the plurality of training samples among the second label space, the plurality of second labels being represented in the second label space; and
obtaining the plurality of classification models based on the determined number.

6. The method of claim 5, wherein obtaining the plurality of classification models comprises: with respect to the classification model in the plurality of classification models, obtaining the classification model by training an initial classification model with the training sample and a classification of whether the second label matches a classification criterion in the second label space.

7. The method of claim 1, wherein determining the predication model comprises:
generating a base model based on the plurality of classification models;
determining an inverse mapping function for mapping a label in the second label space into a label in the first label space; and
determining the predication model based on the base model and the inverse mapping function.

8. The method of claim 7, wherein generating the base model comprises: generating the predication model based on a summation of the plurality of classification models.

9. The method of claim 7, further comprising: in response to receiving a target t sample, determining a target t label in the first label space for the target t sample based on the target t sample and the prediction model.

10. The method of claim 9, wherein determining the target t label base on the target t sample and the prediction model comprises:
determining an intermedia label in the second label space based on the target t sample and the base model in the prediction model; and
determining the target t label based on the intermedia label and the inverse mapping function.

11. An electronic device, comprising a computer processor coupled to a computer-readable memory unit, the memory unit comprising instructions that when executed by the computer processor implements a method for sample processing, comprising:
mapping a first label for a training sample in a plurality of training samples into a second label based on the first label and a plurality of first labels for the plurality of training samples, the first label and the plurality of first labels being represented in a first label space and the second label being represented in a second label space smaller than the first label space;
obtaining a plurality of classification models based on the second label and the training sample, a classification model in the plurality of classification models describing an association relationship between a sample and a classification of a label, represented in the second label space, for the sample; and
generating a predication model based on the plurality of classification models, the predication model describing an association relationship between a sample and a label, represented in the first label space, for the sample.

12. The device of claim 11, wherein mapping the first label into the second label comprises:
determining a mapping function for mapping a label in the first label space into a label in the second label space, the first label space representing a continuous space and the second label space representing an ordinal space; and
determining the second label based on the first label and the mapping function.

13. The device of claim 12, wherein determining the mapping function comprises:
determining a normalizing function for converting the label in the first label space into a normalized value in a third label space based on the label in the first label space and the plurality of first labels; and
determining a bucket function for converting the normalized value into the label in the second label based on a comparison between the normalized value and the third label space.

14. The device of claim 13, wherein determining the bucket function comprises:
determining the number of the buckets based on a predetermined accuracy level;
dividing the third label space into a plurality of buckets based on the determined number of the buckets; and
obtaining the bucket function based on a comparison between the normalized value and the plurality of buckets.

15. The device of claim 11, wherein obtaining the plurality of classification models comprises:
determining the number of the plurality of classification models based on a distribution of a plurality of second labels for the plurality of training samples among the second label space, the plurality of second labels being represented in the second label space; and
obtaining the plurality of classification models based on the determined number.

16. The device of claim 15, wherein obtaining the plurality of classification models comprises: with respect to the classification model in the plurality of classification models, obtaining the classification model by training an initial classification model with the training sample and a classification of whether the second label matches a classification criterion in the second label space.

17. The device of claim 11, wherein determining the predication model comprises:
generating a base model based on a summation of the plurality of classification models;
determining an inverse mapping function for mapping a label in the second label space into a label in the first label space; and
determining the predication model based on the base model and the inverse mapping function.

18. The device of claim 17, the method further comprises: in response to receiving a target t sample, determining a target t label in the first label space for the target t sample based on the target t sample and the prediction model.

19. The device of claim 18, wherein determining the target t label base on the target t sample and the prediction model comprises:
determining an intermedia label in the second label space based on the target sample and the base model in the prediction model; and
determining the target label based on the intermedia label and the inverse mapping function.

20. A computer program product, the computer program product comprising a computer readable storage medium having program instructions embodied therewith, the program instructions executable by an electronic device to cause the electronic device to perform a method for sample processing, the method comprises:
mapping a first label for a training sample in a plurality of training samples into a second label based on the first label and a plurality of first labels for the plurality of training samples, the first label and the plurality of first labels being represented in a first label space and the second label being represented in a second label space smaller than the first label space;
obtaining a plurality of classification models based on the second label and the training sample, a classification model in the plurality of classification models describing an association relationship between a sample and a classification of a label, represented in the second label space, for the sample; and
generating a predication model based on the plurality of classification models, the predication model describing an association relationship between a sample and a label, represented in the first label space, for the sample.
